(19) United States
(12) Patent Application Publication
(10) Pub. No.: US 2018/0111255 A1
(43) Pub. Date: Apr. 26, 2018

(54) Tub and Shower Valve Pressure Balance Cartridge Remover

(71) Applicant: Brian Ockstadt, Ruskin, FL (US)

(72) Inventor: Brian Ockstadt, Ruskin, FL (US)

(21) Appl. No.: 15/655,767

(22) Filed: Jul. 20, 2017

Related U.S. Application Data
(60) Provisional application No. 62/410,818, filed on Oct. 20, 2016.

(51) Int. Cl. B25B 27/24

(52) U.S. Cl. CPC B25B 27/24; E03C 1/041

(57) ABSTRACT

An apparatus for removing a broken pressure balanced valve cartridge from the valve body without breakage of the cartridge. This apparatus operates to separate the inner cartridge piece from the valve by exerting primarily axial forces on the cartridge during removal. The apparatus utilizes a pair of long, low profile forks with hooks on the end that are designed to be inserted in between the valve body and inner piece of a broken pressure-balanced valve cartridge. These forks are connected to an alignment device, which aligns the forks once they have been inserted in between the valve body and pressure-balanced valve cartridge, to the specific angle required to allow the hooks to engage the inner piece of the cartridge for removal. Running through the alignment device is a threaded rod with a handle on the top and a swivel block on the bottom. The threaded rod generates the axial force to remove the broken pressure balanced valve cartridge from the valve body.

### CROSS-REFERENCE TO RELATED APPLICATIONS

This application claims priority to provisional application U.S. Ser. No. 62/410,818 filed Oct. 20, 2016. Said application is incorporated by reference herein in its entirety.

### FIELD OF THE INVENTION

The present invention relates generally to plumbing tools and more specifically the tools for repairing faucet valves.

### BACKGROUND

Pressure-balanced valves provide water at nearly constant temperature to a shower or bathtub, despite pressure fluctuations in either the hot or cold supply lines.

If someone flushes a toilet while the shower is in use, the fixture suddenly draws a significant amount of cold water from the common supply line, causing a pressure drop. In the absence of a compensating mechanism, the relatively higher pressure in the hot water supply line will cause the shower temperature to rise just as suddenly, possibly reaching an uncomfortable or even dangerous level. Conversely, if someone opens a hot water faucet elsewhere, the relatively higher pressure in the cold water supply line will cause the shower temperature to drop suddenly.

The pressure-balanced shower valve compensates for changes in water pressure. It has a diaphragm or piston inside that reacts to relative changes in either hot or cold water pressure to maintain balanced pressure. As water pressure drops on one supply line, the valve reduces the pressure in the other supply line to match. A side effect of this is that the pressure and flow at the shower head or tub spigot will drop twice as much as if only one supply line had been affected, but without a large temperature change. There are ball bearings in the valves to regulate forces.

The use of pressure-balanced valves can prevent scalding injuries, in particular to the elderly, the infirm, to children and infants. For this reason, some municipalities require by building codes to have pressure balanced valves installed in shower systems.

Pressure balanced valves are installed in the shower valve in the piping behind the wall. For this reason, repair and replacement of these valves has historically been a costly repair, because the replacement will entail cutting into the wall, cutting the valve out of the piping, soldering a new valve in place, and any associated wall and tile repairs needed to access the valve.

To alleviate this issue, pressure-balanced valve manufacturers have developed valve bodies and a replacement cartridge system for pressure balanced valves (U.S. Pat. No. 5,355,906). The valve bodies are soldered into the piping behind the wall, but the parts of the valve which typically fail are encased in a replace-able cartridge which is accessible from outside the wall, by removing the faucet face handle from the shower/tub side.

The exterior of pressure balanced valve cartridges are composed of two pieces which enclose the innards of the valve, an inner piece, which when installed is inside the valve body protruding towards the piping, and the outer piece, which when installed protrudes from the valve body towards the shower.

When removing these cartridges for replacement the manufacturer's recommended cartridge removal procedure is: 1) turning off the water, 2) removed faucet handle and trim, 3) remove threaded cartridge retainer ring, 4) use your hand to grab and then pull on the outer piece of cartridge while lifting up and down at the same time to wrest the cartridge from the valve body.

The manufactures removal instructions are adequate for removing a recently installed cartridge from a valve body, or applications where the water purity is ideal. However, for applications where the cartridge has been in use for some time, and the water purity is less than ideal, scale will build up on the valve body's brass bore that the cartridge fits into with sealed O-rings.

Additionally, as the plastic cartridges age over time they become more brittle, less pliable, and more susceptible to breakage where the inner and outer pieces of the cartridge are sealed together when lateral forces strain this connection point.

The scale in the valve decreases the diameter of the bore, increasing the compressive forces in the O-rings thereby increasing the force required to remove the cartridge from the valve body for replacement. When this occurs, the person removing the cartridge will typically utilize more force to wrest the cartridge from the valve body, more than the cartridge was designed to tolerate, and the inner and outer pieces of the valve will separate, and the inner piece will remain affixed in the valve body.

Once the inner and outer pieces of the cartridge have separated and the user is left to remove the cartridge by the inner piece alone, the task becomes considerably more difficult. The inner piece of the cartridge has no available locations for the person removing the cartridge to grip it by hand, and any sections which can be access by conventional removal tools such as pliers will readily break when any force is applied. At this point, a professional must be contracted to attempt to remove the cartridge remains, typically by prying, chipping, drilling, and heating the valve body with a torch; or the wall may need to be opened and the entire valve body removed and replaced, a costly repair.

Due to the tight tolerances between the inside of the valve body and the cartridge, traditional tools are not particularly useful in removing a cartridge which has become affixed in the valve body due to scale build up. Pliers and other gripping aids can only access the outer piece of the cartridge, and when using these apparatuses the uses is capable of exerting more lateral force as well are axial force on the outer piece of the cartridge, increasing the potential to separate the inner and outer pieces of the valve if the user exerts too much lateral force on affixed cartridge when trying to remove it from the valve body.

Thus, there exists a need for an apparatus which is capable of removing a broken pressure balanced valve cartridge from the valve body without breakage of the cartridge. This apparatus should operate to separate the inner cartridge piece from the valve by exerting primarily axial forces on the cartridge during removal.

### SUMMARY

To accomplish this objective, the apparatus of the present invention is utilizes a pair of long, low profile forks with hooks on the end that are designed to be inserted in between the valve body and inner piece of a broken pressure-balanced valve cartridge. These forks are connected to an alignment device, which aligns the forks once they have been inserted in between the valve body and pressure-balanced valve cartridge, to the specific angle required to allow the hooks to engage the inner piece of the cartridge for removal. Running through the alignment device is a threaded rod with a handle on the top and a swivel block on the bottom.

To utilize the apparatus to remove a pressure-balanced valve cartridge which has become affixed to the valve body, the user will first insert the forks vertically into valve in between the valve body and pressure-balanced valve cartridge. After insertion, the forks are aligned to the proper angle so that the hook engages the inner piece of the cartridge using the alignment device. Additionally, the swivel block is aligned so that it is in contact with the top of the valve body.

Once the forks and swivel blocks are properly aligned, the user turns the handle so that the threading forces the swivel block and the alignment device away from each other. In doing so, the device create pressure between the swivel block and valve body, which will be transferred to the hooks engaged with the inner piece of the valve cartridge, creating an axial force which will separate the cartridge from the valve body, without breaking the cartridge.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

FIG. 1 illustrates a front view of the first embodiment of the current invention;

FIG. 2 illustrates how the inserted the first embodiment of the current invention is engaged with the inner cartridge piece to remove an affixed inner cartridge piece;

FIG. 3 illustrates the first embodiment of the current invention is inserted into the valve body to before the gripping forks are engaged with the alignment bar notches;

FIG. 4 illustrates perspective, front, and side views of a gripping fork on the first embodiment of the current invention;

FIG. 5 illustrates a second embodiment of the current invention;

FIG. 6 illustrates a third embodiment of the current invention.

FIG. 7 illustrates a front view of the fourth embodiment of the current invention with the gripping forks in the open position.

FIG. 8 illustrates a perspective view of the fourth embodiment of the current invention with the gripping forks in the open position.

FIG. 9 illustrates a front view of the fourth embodiment of the current invention with the gripping forks in the closed position.

FIG. 10 illustrates a perspective view of the fourth embodiment of the current invention with the gripping forks in the closed position.

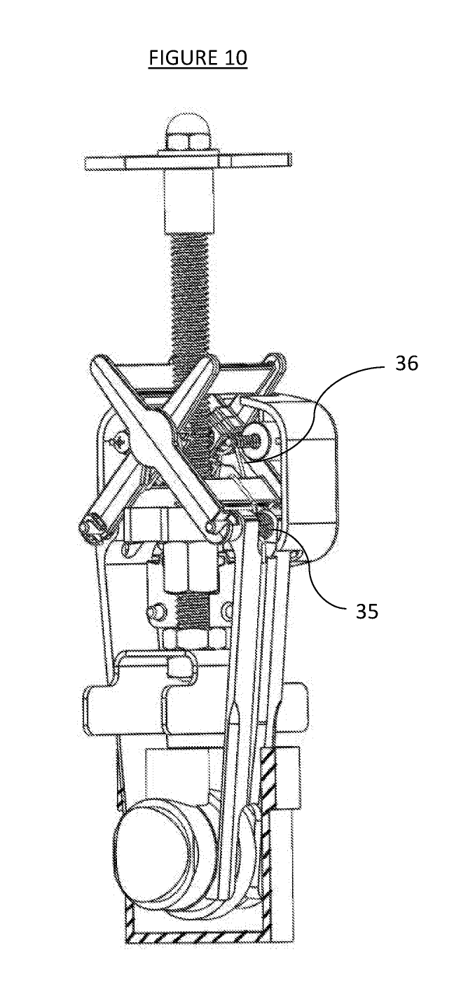

### DETAILED DESCRIPTION OF THE INVENTION

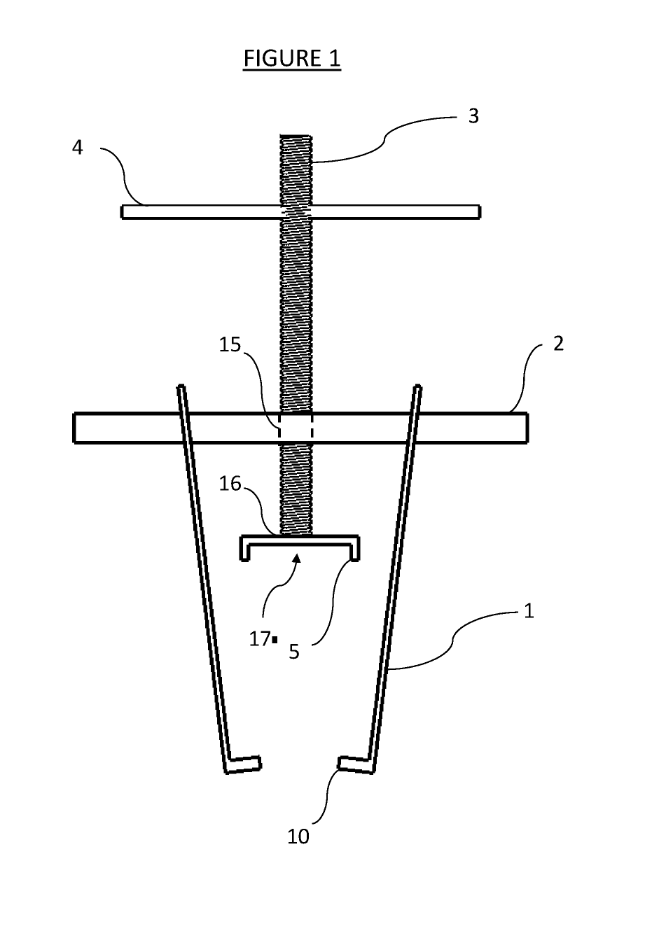

Referring to FIG. 1, the first embodiment of the Tub and Shower Valve Cartridge Puller of the current invention is primarily comprised of the following components: a pair of gripping forks 1, an alignment structure 2, threaded rod 3, a handle 4, and a crossbar 5.

The device is utilized to remove the affixed inner piece of the pressure-balance valve cartridge 6 from a valve body 9. The exterior of pressure-balanced valve cartridges 6 are comprised of two pieces which enclose the innards of the valve, an inner piece, which when installed is inside the valve body 9 protruding towards the piping, and the outer piece (not pictured), which when installed protrudes from the valve body 9 towards the shower. In order for the device to be utilized, the inner and outer pieces of the cartridge must have be already been separated from each other, and only the inner piece of the valve remains affixed in valve body 9. As the pressure balanced valves 6 are designed today removal of the outer piece of the cartridge is necessary to provide access to the inner piece for the gripping forks 1 to engage with the inner piece of the valve cartridge 6. If in the future the geometry of the valve cartridges 6 were to change so that the gripping forks 1 could engage with the inner piece of the valve cartridge 6 while the valve cartridge 6 was still intact, the requirement for the inner and outer pieces of the cartridge to be separated from each other to utilize the device could be removed.

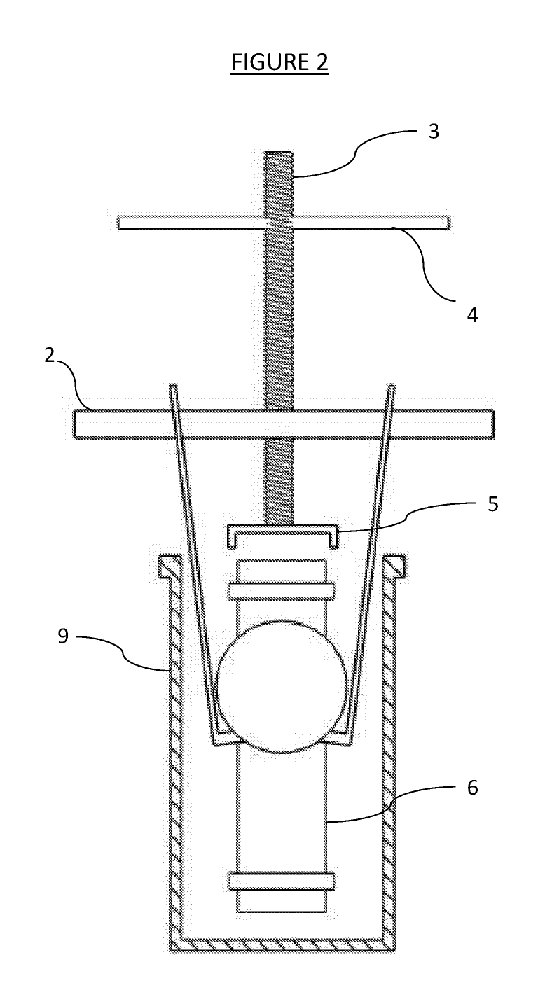

Referring to FIG. 2, the two gripping forks 1 are rectangular shaped, with hooked shaped bottom ends 10 for engaging the inner piece of a pressure-balance valve cartridge 6 which has become affixed to the valve body 9. There is a open channel 11 cut in each gripping forks 1 which extends from the bottom upward which allows the fork 1 to avoid engaging a protrusion which extends up the sides of the valve cartridge 6 where the hooks 10 engage with the cartridge 6. Additionally, at the top of each of the forks 1 there is an enclosed channel 13 going through the fork 1 which allows the forks 1 to connect with the alignment structure 2.

The thickness of the gripping forks 1 and hook ends 10 at its maximum point must be thin enough to fit between the valve body 9 and valve cartridge 6 and be capable of being rotated to the point where the hook end 10 will engage with the valve cartridge 6 sufficiently so that the hook end 10 can provide sufficient axial force to free and affixed valve cartridge 6 from the valve body 9.

The gripping forks 1 of the are designed to function with the geometry of pressure-balanced valves as they exist today. If the geometry of the pressure-balance valve cartridges 6 and valve bodies 9 were to change in the future, one skilled in the art would be capable of adjusting the design of the gripping forks 1 to achieve the same function of as they currently perform with the current valve design.

Referring to FIG. 1 the first embodiment of the Tub and Shower Valve Cartridge Puller also comprises an alignment structure 2. The alignment structure 2 is a rectangular shaped bar with two notches 14 in both ends, and a hole 15 with threading in the center. The notches 14 in the alignment structure 2 are angled towards the center of the device at the precise angle to align the gripping forks 1 so that the gripping forks 1 engage with the cartridge 6 without interference with the valve body 9. Additionally, the hole 15 with threading in the center of the alignment structure 2 is tapped with a diameter and threading to match the threaded rod 3.

Referring to FIG. 1 the threaded rod 3 runs through alignment structure 2. The threaded rod 3 has a handle 4, or other means for providing a rotational force to the threaded rod at the top of the rod 3. The bottom of the rod 3 is connected to the crossbar 5 via an axle connection 16 which allows the threaded rod 3 independently rotate without imparting any rotational on the crossbar 5. This connection can be achieve through the use of a bearing, bushing, or other means of creating this type of connection known to those skilled in the art.

Referring to FIG. 1, the crossbar 5 is attached to the threaded rod 3 and has a minimum length equal to the diameter of the valve body 9. In the center of the crossbar is a recess 17 which allows the cartridge inner piece to be separated from the valve body 9 into the removal device as the cartridge inner piece is pulled upward for the valve body 9 as the broken cartridge is removed from the valve. In the first embodiment the crossbar 5 is simply created with a “C” channel bar, however, one skilled in the art would be capable of adjusting the design of the crossbar 5 to achieve the same function it currently perform with a number of designs which would not change the functionality of the device.

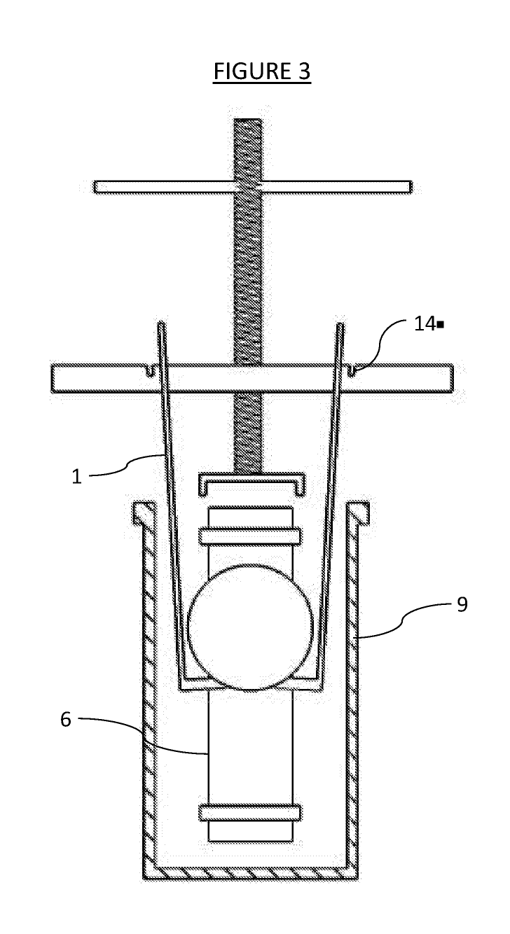

Referring to FIGS. 3 & 4, to utilize the device to remove the inner piece of a pressure balanced valve cartridge 6 which is affixed to the valve body 9 and which the outer piece of the cartridge has been separated from the inner piece, the device with the gripping forks 1 oriented vertically is inserted into the valve. The device is aligned with the valve so that the gripping forks 10 are inserted into the cavities between the valve cartridge 6 and the valve body 9.

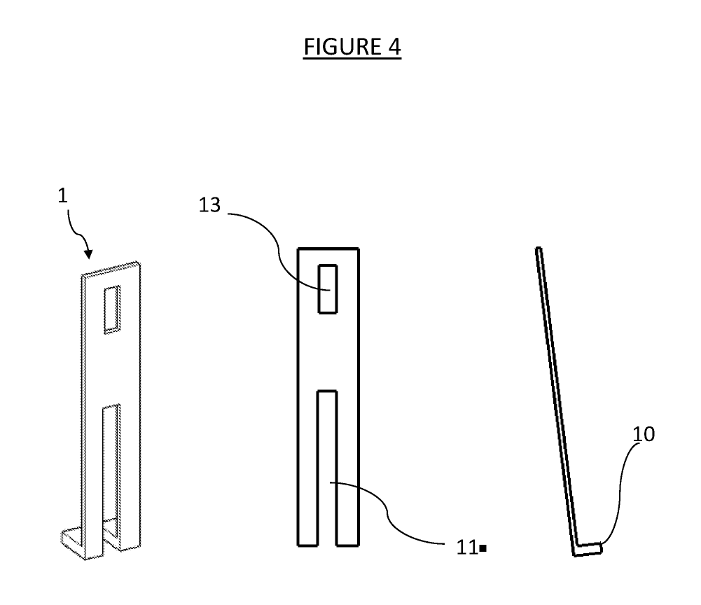

Referring to FIG. 4, once the device has been inserted into the valve body 9 the gripping forks 1 are aligned so that the closed channel 13 in each of the gripping forks 1 are engaged with the notches 14 of the alignment structure 2. Once the forks 1 and the alignment structure 2 are engaged with each other, the hooks 10 will be engaged with the underside of the cartridge 6.

After the hooks 10 are in place, the user will use the handle 4 to twist the threaded rod 3 in the direction (either clockwise or counter-clockwise) that will force the crossbar 5 to travel away from the alignment structure 2 until the crossbar 5 comes into light contact with the top of the valve body. At this point the user will align the crossbar 5 with the valve cartridge 6 so that the recess in the crossbar 17 is aligned with the cartridge 6 so that during the removal process the cartridge 6 can travel up into the recess 17.

Once the gripper forks 1 and crossbar 5 have been properly aligned, the user will start to remove the cartridge 6 by twisting the handle 4 in the direction (either clockwise or counter-clockwise) that will force the crossbar 5 to travel away from the alignment structure 2 so that a compressive force is created between the crossbar 5 and the valve body 9. Since both the crossbar 5 and valve body 9 are constructed of rigid materials, the force will be transferred through the alignment structure 2, gripping forks 1, and inner valve cartridge, to the joint where the cartridge 6 and the valve body 9 are conjoined, the weakest link in the structure. At this joint, this transferred force will create a tensile force separating the cartridge 6 from the valve body 9. The user will continue to twist the threaded rod 3 so that the valve cartridge 6 is drawn into the recess in the crossbar 17 until the cartridge 6 is completely separated and free from the valve body 9.

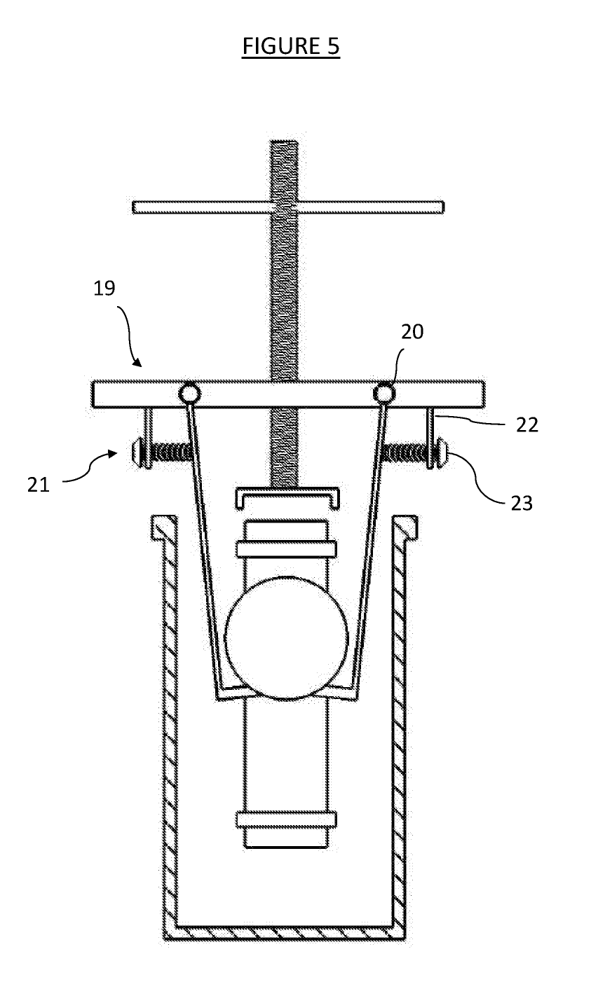

Referring to FIG. 5, a second embodiment of the current invention replaces the use of the alignment structure notches 14 and closed fork channel 13 in the first embodiment with a hinged system 19. In this embodiment the gripping forks 1 are attached to the alignment structure 2 with pins to create hinged connections 20. In addition to the hinged connections 20, angle adjustment apparatuses 21 are affixed to either end of the adjustment bar 2 as well on the outside of the hinged connections 20. Each angle adjustment apparatus 21 consist of a metal bar 22 fixedly attached to the adjustment bar 2 and protruding downward, and an adjustment screw 23 that is threaded through the metal bar 22 perpendicular to the metal bar 22.

When utilizing the second embodiment, the angle adjustment screws 23 are backed out of the threaded hole to the point that the gripping forks 1 hang vertically, for insertion into the valve body 9 in the same manner as is done when using the first embodiment. Once the gripping forks 1 are fully inserted into the valve body 9, the hooks 10 are engaged with the cartridge 6 by threading the adjustment screws 23 towards the gripping forks 1 until they engage with the hinged gripping forks 1 and eventually force the gripping forks 1 to engage with the underside of the affixed cartridge 6. Once the gripping forks 1 have engaged with the underside of the affixed cartridge 6, the user once again will twist the threaded rod 3 until the stuck cartridge 6 is completely separated and free from the valve body 9.

The advantage of the second embodiment is that is allows for greater alignment variability of the gripper forks 10, allowing the device to be used with a larger range of configurations. The disadvantage is that the increased complexity of the device will increase the overall cost of manufacture. Additionally, at this juncture in time, the increased range of configurations is not required, as the first embodiment is capable of workings with the pressure balanced valve configurations currently commercially available. However, as new configurations may become commercially available, the need for a removal device with increased range may also become commercially necessary.

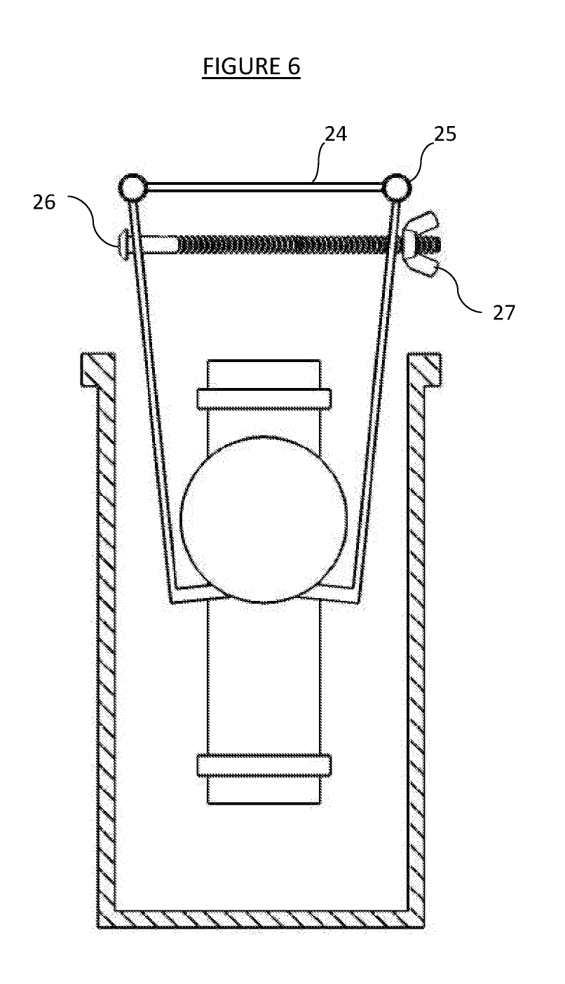

Referring to FIG. 6, a third embodiment of the current invention replaces the use of the threaded rod 3, alignment structure 2, and crossbar 5 to generate the force to separate the affixed cartridge from the valve body and instead only has a handle 24 which the use with pull on to generate the force to remove the cartridge 6. With this embodiment, the gripping forks 1 are attached to the handle via hinged connections 25. Additionally, a threaded adjustment rod 26 with wing nut 27 connects the two gripper forks 1 together.

When utilizing this third embodiment, the threaded adjustment rod 26 wing nut 27 is backed out to the point that the gripping forks 1 hang vertically, for insertion into the valve body 9 in the same manner as is done when using the previously discussed embodiments. Once the gripping forks 1 are fully inserted into the valve body 9, the hooks 10 are engaged with the cartridge 6 by threading the wing nut 27 along the threaded rod 26, towards the gripping forks 1, until they engage with the hinged gripping forks 1 and eventually force the hooks 10 to engage with the underside of the affixed cartridge 6. Once the hooks 10 are engaged, the user simply pulls on the handle 24 to remove the cartridge 6 from the valve body 9.

The advantage of the third embodiment is that it is the simplest, and least expensive to manufacture. However, the drawback is that the axial force to remove the affixed cartridge is generated by the user, instead of by machine. For this reason, it is possible that the user may generate lateral forces in addition to axial force. Generating axial forces are not ideal because once the affixed cartridge 6 is freed from the valve body 9, the lateral forces could cause the device to contact and damage the valve body 9 as it is removing the cartridge 6. Also, it could create additional stresses on the piping attached to the valve body 9, potentially creating leaks in the piping as well.

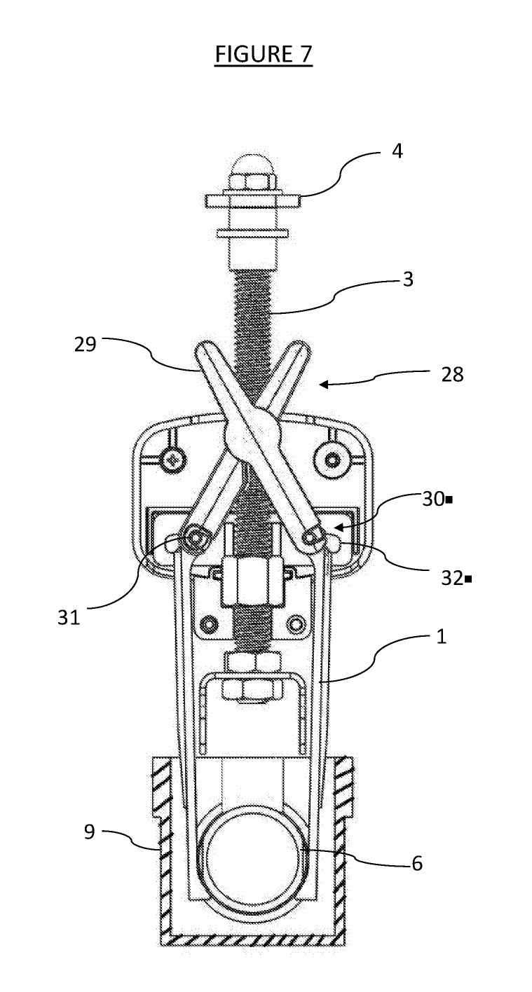

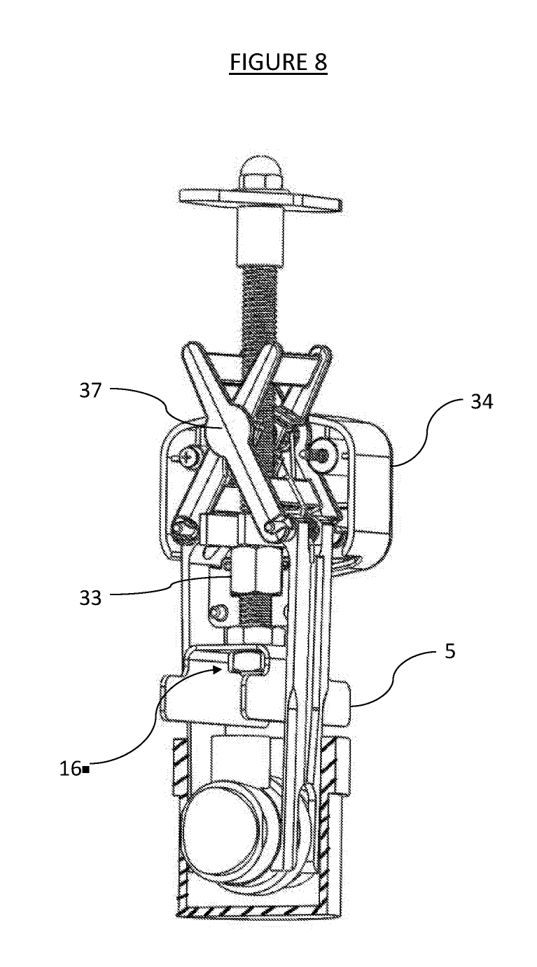

Referring to FIGS. 7, 8, 9, & 10, a fourth embodiment of the current invention utilizes a first-class double-lever assembly 28 to position the gripping forks 1 for insertion into the valve body 9 and to engage the valve cartridge 6. The gripping forks 1 are attached to lower ends of the pivoting lever arms 29 by hinged connections 30 utilizing pivot pins 31. The running through the pivot pins and terminating into the gripping forks 1 are attached to lower ends of the pivoting lever arms 29 are first set of torsion springs 35. The motion of the pivot lever arms 29 and gripper forks 1 are guided by pin guides 32 in the two-piece encasement (only 1 piece is depicted) 34.

Running through the first-class double-lever assembly 28 is a threaded rod 3. The threaded rod 3 has a handle 4, or other means for providing a rotational force to the threaded rod 3 at the top of the rod 3. The bottom of the rod 3 is connected to the first-class double-lever 28 via a threaded nut 33, and a two-piece encasement 34 which encompasses the first-class double-lever assembly 28 and holds the threaded nut 33 in a fixed position without interfering with the pivot motion of the first-class double-lever assembly 28. The two piece encasement 34 and threaded nut 33 allows the threaded rod 3 to independently rotate without imparting any rotational force on the first-class double-lever assembly 28. The bottom of the rod 3 is connected to the crossbar 5 via an axle connection 16 which allows the threaded rod 3 independently rotate without imparting any rotational on the crossbar 5.

Referring to FIGS. 7 & 8, the gripping forks 1 are tensioned to be closed by default by the first set of torsion springs 35. The pivoting lever arms 29 are also tensioned to default into their open position by a second torsion springs 36 located at their common centralized pivot point 37. To operate, the user will squeeze together the upper sections pivoting lever arms 29 bringing the pivot pins 31 into the central most position of the pin guides 32. When in this position, the first set of torsion springs 35 are relaxed and the gripping forks 1 only exert passive forces against the valve cartridge 6, allowing the gripper forks 1 to slide over the valve cartridge 6 when inserted into the valve body 9.

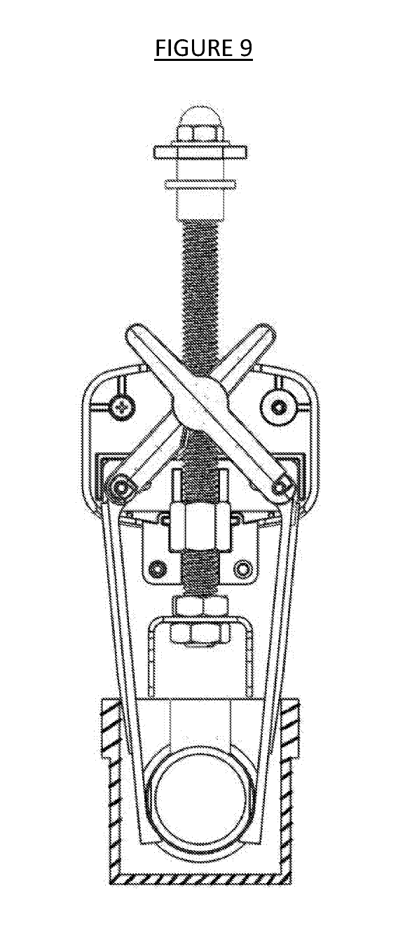

Referring to FIGS. 9 & 10, once the gripping forks 1 are inserted, the user can release their squeeze and the second torsion spring 36 will return the pivoting lever arms 29 to their extended outward most position, and the first set of torsion springs 35 are tensioned, and the gripping forks 1 exerts pressure against the valve cartridge 6, engaging the gripper forks 1 with the valve cartridge 6 so the valve cartridge 6 can be removed the valve body 9.

It would be appreciated by those skilled in the art that various changes and modifications can be made to the illustrated embodiments without departing from the spirit of the present invention. All such modifications and changes are intended to be covered by the appended claims.

What is claimed is:

1. A device for removing an affixed pressure-balanced valve cartridge from the pressure-balanced valve body comprising:
a pair of opposing gripper forks, each gripper fork having a upper and lower end;
the lower end of each gripper fork contoured to allow the fork to securably engage with the underside of the affixed pressure-balanced valve cartridge;
a structure for connecting the upper ends of each gripper fork to form a single contiguous unit capable of taking a single force applied to said structure and transferring the force evenly to each of the lower ends of the gripper forks;
a means for orienting the angle of said gripper forks relative to said structure;
whereas said device is operated by orienting the gripper forks and an angle relative to said structure where the gripper forks can be inserted into the pressure-balanced valve body to a point where the lower ends of the each gripper fork can engage with the underside of the affixed pressure-balanced valve cartridge, re-orienting the gripper forks such that the contours of the lower end of each gripper fork securably engage with the underside of the affixed pressure-balanced valve cartridge,
wherein exerting an upward force on said structure for connecting the upper ends of each gripper fork to form a single contiguous exerts an upward force on the gripper forks to remove the affixed pressure-balanced valve cartridge from the pressure-balanced valve body.

2. The device for removing an affixed pressure-balanced valve cartridge from the pressure-balanced valve body of claim 1, wherein said means for orienting the angle of said gripper forks relative to said structure further comprises;
hinges connecting the upper ends of each gripper fork to the structure for connecting the upper ends of each gripper fork to form a single contiguous unit capable of taking a single force applied to said structure and transferring the force evenly to each of the lower ends of the gripper forks;
a first adjustment device which is attached to the upper ends of each gripper fork, connecting the two gripper forks together, wherein the first adjustment device comprises a means for linear adjustment of the length of the first adjustment device, whereby adjustment of the length of the first adjustment device will exert a force on each gripper fork, adjusting the angle of said gripper forks relative to said structure.

3. The device for removing an affixed pressure-balanced valve cartridge from the pressure-balanced valve body of claim 2, wherein said a first adjustment device which is attached to the upper ends of each gripper fork, connecting the two gripper forks together further comprises a threaded rod which travels through the two gripper forks with at least one mating threaded nut which travels along the threaded rod.

4. The device for removing an affixed pressure-balanced valve cartridge from the pressure-balanced valve body of claim 1, further comprising a force transferring device with an upper and lower end, the upper end connected to said structure for connecting the upper ends of each gripper fork to form a single contiguous unit and the lower end capable of contacting said wherein said pressure-balanced valve body;
wherein the force transferring device comprises a means for exerting a downward force on said pressure-balanced valve body where the lower end contacts the pressure-balanced valve body;
wherein exerting said downward force on said pressure-balanced valve body transfers the downward force from the point of contact between the lower end and the pressure-balanced valve body to and upward force against said structure for connecting the upper ends of each gripper fork.

5. The device for removing an affixed pressure-balanced valve cartridge from the pressure-balanced valve body of claim 4, wherein the force transferring device further comprises a threaded rod thread-ably connected to said structure for connecting the upper ends of each gripper fork.

6. The device for removing an affixed pressure-balanced valve cartridge from the pressure-balanced valve body of claim 4, wherein said means for orienting the angle of said gripper forks relative to said structure further comprises;
notches, located at each end of of said structure for connecting the upper ends of each gripper fork, wherein the notches are angled towards the center of the device at an angle which aligns the gripping forks so that the gripping forks engage with the pressure-balanced valve. a channel at the upper end of each said gripping fork which allows the gripping forks to securably engage each gripping fork with each notch.

7. The device for removing an affixed pressure-balanced valve cartridge from the pressure-balanced valve body of claim 4, wherein said means for orienting the angle of said gripper forks relative to said structure further comprises;
hinges connecting the upper ends of each gripper fork to the structure for connecting the upper ends of each gripper fork to form a single contiguous unit;
angle adjustment apparatuses affixed to either end of the structure for connecting the upper ends of each gripper fork capable of altering the angle of the gripping forks in relation to the structure for connecting the upper ends of each gripper fork.

8. A device for removing an affixed pressure-balanced valve cartridge from the pressure-balanced valve body comprising:
a first-class double-lever comprising a pair pivoting lever arms with upper and lower ends;
a pair of opposing gripper forks, each gripper fork having a upper and lower end attached to the lower ends of the pivoting lever arms;
the lower end of each gripper fork contoured to allow the fork to securably engage with the underside of the affixed pressure-balanced valve cartridge;
wherein exerting a forces on the upper ends of said pivot arms will position the gripper forks for insertion into the pressure-balanced valve body and will position the gripper forks to securably engage with the underside of the affixed pressure-balanced valve cartridge;
a force transferring device with an upper and lower end, the upper end connected to said first-class double-lever and the lower end capable of contacting said wherein said pressure-balanced valve body;
wherein the force transferring device comprises a means for exerting a downward force on said pressure-balanced valve body where the lower end contacts the pressure-balanced valve body;
wherein exerting said downward force on said pressure-balanced valve body transfers the downward force from the point of contact between the lower end and the pressure-balanced valve body to and upward force against said structure for connecting the upper ends of each gripper fork.
